(19) United States
(12) Patent Application Publication
(10) Pub. No.: US 2010/0062075 A1
(43) Pub. Date: Mar. 11, 2010

(54) Germicidal coating on hand held remote control devices for controlling electrical and electronic devices

(75) Inventors: John Schinder, Ladera Ranch, CA (US); William Pat Price, Rhome, TX (US)

Correspondence Address: Law Office of Scott C Harris Inc, PO Box 1389, Rancho Santa Fe, CA, 92067, US

(73) Assignee: VIZIO, INC, Irvine, CA (US)

(21) Appl. No.: 12/206,666

(22) Filed: Sep. 8, 2008

(51) Int. Cl. A01N 59/16; A01P 1/00

(52) U.S. Cl. 424/618

(57) ABSTRACT

The current invention addresses an issue where hand held remote control devices and other consumer electronics products can become a carrier of infectious germs or bacteria once touched by a person or animal carrying a pathogen or infectious agent. School aged children and house hold pets may be the carrier of such pathogens. Adults or any other person inflicted with a common illness such as a cold or flu can infect a hand held remote or other consumer electronic product which in turn can transmit those germs to the next person or persons who handle the remote. The present invention is intended to minimize the effects of pathogen transmission from person to person by killing the pathogens once they are deposited on such a consumer electronic product.

### BACKGROUND

There are many ways in which infectious pathogens such as bacteria or germs are spread from one person to another in a family or public place. Most residences have multiple hand held remote control devices for televisions, audio players, light dimmers, and other devices used in the residence. Children often carry infectious agents from school where they were acquired from other children who may have been sick. Typically all members of a family will handle hand held remote control devices. These devices become a prime point of contact and transfer of germs, bacteria, and virus'.

### SUMMARY

It is an object of the present invention to provide a measure of protection against the spread of infectious germs and other pathogens that have been deposited onto the surface of a hand held remote control device by a person or persons who are infected and have touched the remote control device.

An aspect of this disclosure is intended to minimize the transference of pathogens that are deposited on hand held remote control devices used by multiple members of a family or group.

### BRIEF DESCRIPTION OF THE DRAWINGS

Embodiments of the present invention are illustrated by way of example, and not by way of limitation. The following figures and the descriptions both brief and the detailed descriptions of the invention refer to similar elements and in which:

FIG. 1 depicts one half of a hand held remote shell with a painted germicidal coating

FIG. 2 depicts the upper and lower halves of a hand held remote control shell with a printed circuit assembly and a push button assembly between the shell pieces

FIG. 3 depicts the upper view of a hand held remote control shell with holes for and the button assembly shown.

### DETAILED DESCRIPTION OF THE INVENTION

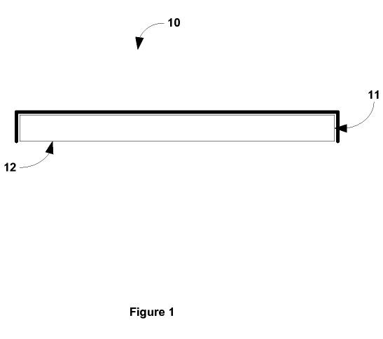

Now referencing FIG. 1 where 10 depicts a side view of one portion of a hand held remote control device 12. Said one portion of hand held remote control device 12 is covered by a coating 11 with said coating 11 being comprised of a plurality of chemical compounds where at least one portion of said chemical compound acts as a carrier for another at least one portion of said chemical compound acting as the germicidal agent of said chemical compound. In one embodiment said coating 11 is applied to said one portion of hand held remote control device 12 as a paint which may have been applied by brush, spray or electroplating or other electrostatic application technique. Another alternative is that one portion of hand held remote control device 12 being dipped into a pool or reservoir of said chemical compound. In another embodiment, said coating consisting of a plurality of said chemicals may have been electroplated onto the surface of said one portion of hand held remote control device 12.

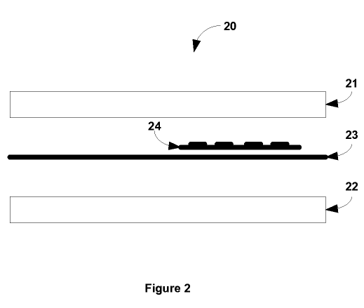

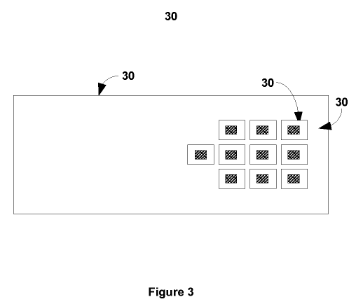

FIG. 2 shows a depiction 20 where a top portion of hand held remote control device 21 is mated to a bottom portion of hand held remote control device 22. These two portions of hand held remote control device contain printed circuit assembly 23 and one version of a possible plurality of push button assemblies. In one embodiment of push button assembly 24, said push button assembly 24 is constructed of a molded rubberized compound and may contain, as part of the chemicals comprising said molded rubberized compound, a germicide chemical. When said top portion of hand held remote control device 21 is mated to a bottom portion of hand held remote control device 22, printed circuit assembly 23 and said push button assembly 24 will be encased within the confines of said top portion of hand held remote control device 21 and said bottom portion of hand held remote control device 22. Holes or openings on said top portion of hand held remote control device 21 will allow the button portions of said push button assembly 24 to stick above the surface of said top portion of hand held remote control device 21 thus allowing a user to press said push buttons as depicted in FIG. 3. FIG. 3 depicts the top view of said top portion of hand held remote control device 21 with 10 push buttons protruding out of the top surface of said top portion of hand held remote control device 21.

The germicidal chemical or compound is any of a plurality of chemicals or compounds such as but not limited to any form of silver; titanium dioxide; or any chemical or compound exhibiting antibacterial properties.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other items other than handheld digital television remote control devices such as automotive entry and security remote control devices, handheld remote control devices for audio systems, audio headphones comprised of plastic shells with encased electronics and soft ear cushions, or audio ear phones comprised of plastic shell(s) with encased electronics and soft materials intended for insertion into the outer ear canal are intended to be covered by this invention expressed by the claims for this invention.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

The invention claimed is:

1. A paint like compound intended for direct application on plastic shells of hand held remote control devices consisting of:
a. a chemical coating with properties of paint capable of adhering to a smooth surface;
b. a germicidal chemical or compound to be combined with said chemical coating resulting in a germicidal coating.

2. A compound as in claim 2, wherein said compound has properties intended for spraying onto plastic shells

3. A compound as in claim 1, wherein aid said germicidal chemical or compound is a compound from the group consisting of
i. any form of silver; or
ii. titanium dioxide;

4. An compound as in claim 3, wherein said compound has properties intended for electro plating onto plastic shells.

5. A plastic shell component comprising an outer assembly of a hand held devices enclosing electronic assemblies and coated with a paint like compound having:
a chemical coating with properties of paint capable of adhering to a smooth surface;
a germicidal chemical or compound to be combined with said chemical coating resulting in a germicidal coating.

6. A component as in claim 5, wherein said germicidal chemical or compound is any of a plurality of chemicals or compounds from the group consisting of:
iii. a form of silver; or
iv. titanium dioxide.

7. The component of claim 5 further comprising electrical circuits of hand held television remote control devices associated with said plastic shells.

8. The component of claim 5 further comprising electrical circuits of hand held audio system remote control devices associated with said plastic shells.

9. The component of claim 5 further comprising electrical circuits of hand held digital video camera remote control devices associated with said plastic shells.

10. The component of claim 5, further comprising electrical circuits of hand held digital still camera remote control devices associated with said plastic shells.

11. The component of claim 5 further comprising electrical circuits of hand held automotive security remote control devices associated with said plastic shells.

12. The component of claim 5 further comprising electrical circuits of hand held garage door remote control devices associated with said plastic shells.

13. The component of claim 5 further comprising electrical circuits of hand held residential lighting remote control devices associated with said plastic shells.

14. The component of claim 5 further comprising electrical circuits of hand held water fountain remote control devices associated with said plastic shells.

15. The component of claim 5 further comprising electrical circuits of hand held telephone sets and mating cradles associated with said plastic shells.

16. The component of claim 5 further comprising pressible buttons on said remote control devices not constituting an integral part of the said plastic shells are formed of a compound that includes a germicidal component.

17. A method comprising:
coating a plastic shell component comprising an outer assembly of a hand held devices enclosing electronic assemblies with a paint like compound having:
a chemical coating with properties of paint capable of adhering to a smooth surface, and a germicidal chemical or compound to be combined with said chemical coating resulting in a germicidal coating.

18. A method as in claim 17, wherein said germicidal chemical or compound is any of a plurality of chemicals or compounds from the group consisting of:
i. a form of silver; or
ii. titanium dioxide.

19. The method of claim 17 further comprising electrical circuits of hand held television remote control devices associated with said plastic shells.

20. The method of claim 17 wherein said electrical circuits of hand held audio system remote control devices associated with said plastic shells.

21. The method of claim 17 wherein said electrical circuits of hand held digital video camera remote control devices associated with said plastic shells.

22. The method of claim 17 wherein said electrical circuits of hand held digital still camera remote control devices associated with said plastic shells.

23. The method of claim 17 wherein said electrical circuits of hand held automotive security remote control devices associated with said plastic shells.

24. The method of claim 17 wherein said electrical circuits of hand held garage door remote control devices associated with said plastic shells.

25. The method of claim 17 wherein said electrical circuits of hand held residential lighting remote control devices associated with said plastic shells.

26. The method of claim 17 wherein said electrical circuits of hand held water fountain remote control devices associated with said plastic shells.

27. The method of claim 17 wherein said electrical circuits of hand held telephone sets and mating cradles associated with said plastic shells.

28. The method of claim 17 wherein said pressible buttons on said remote control devices not constituting an integral part of the said plastic shells are formed of a compound that includes a germicidal method.
